(19) United States
(12) Patent Application Publication
(10) Pub. No.: US 2008/0052524 A1
(43) Pub. Date: Feb. 28, 2008

(54) READER FOR ONE TIME PASSWORD GENERATING DEVICE

(76) Inventors: Yoram Cedar, Cupertino, CA (US); Carlos J. Gonzalez, Los Gatos, CA (US)

Correspondence Address: WINSTON & STRAWN, LLP, PATENT DEPARTMENT, 1700 K STREET, N.W., WASHINGTON, DC, 20006, US

(21) Appl. No.: 11/467,070

(22) Filed: Aug. 24, 2006

(51) Int. Cl. H04K 1/00

(52) U.S. Cl. 713/184

(57) ABSTRACT

A portable one time password reader for use in two factor authentication systems and methods allows for the display of a one time password when coupled to a device that generates the value of the password. The reader of the present invention provides power and if appropriate a real time clock signal to these devices in place of the host, so that the devices can generate the real time password without being connected to the host. Therefore, when connected to the generating device, the reader functions not only to display the value, but also to enable generation of the value. The reader may also be coupled to the host and device simultaneously and submit the values to the host and entities coupled thereto.

### CROSS REFERENCE TO RELATED APPLICATIONS

The present invention is related to U.S. patent application Ser. No. ______, Attorney Docket No. SNDK.468US0, entitled “Methods In A Reader For One Time Password Generating Device” to Cedar et al. The present invention is also related to U.S. patent application Ser. Nos. 11/319,835 and 11/319,259 to Gonzalez et al., which are hereby incorporated by reference in the entirety for all purposes.

### FIELD OF THE INVENTION

The present invention relates generally to portable mass storage devices such as the memory cards and portable universal serial bus (“USB”) flash memory drives used to store and transfer large files to and from digital devices, and more specifically relates to security and access control mechanisms implemented within the devices in order to access and log into institutions.

### BACKGROUND

One time passwords, as the name implies, are used only once, and are therefore more robust and provide more security than passwords that are used repeatedly. A one time password (“OTP”) is typically a numerical value generated by an algorithm. When submitted by a user, it is then compared to a reference value generated (elsewhere) by the same algorithm. There are numerous tokens and other devices that can generate and even submit one time password values for a user.

Historically, the dedicated token has been the most commonly used consumer OTP generator. The token has a display that shows the OTP value to be entered, and the user reads the value and inputs it as a password, often with some other credentials or verifying information such as a user name or PIN. Some tokens constantly display a value, whereas others display the value only after a button in pressed. OTP generation can also be time based or event based. In time based generation, the OTP value is incremented at a regular frequency. In event based generation, the OTP value is incremented based upon an unscheduled action or event, for instance when a user presses a button on the OTP token. For a device capable of time based OTP generation, the device should have or utilize a real time clock in order to for the device to increment the value on a regular basis.

As mentioned, the most common form of the tokens to date requires that the user read the value from a screen and enter it into a computer. Another recently developed token allows the token to transmit the value directly to the computer, and in turn to some validating entity. Both of these implementations, and the one time password concept generally, provide a high level of security, but require that the user carry around a token for generation of the one time password values.

A relatively recent trend is the integration of OTP functionality into other more general purpose devices. This relieves the user from having to carry around a token whose only purpose is to generate OTP values. In one example, the OTP generation is integrated into a USB flash drive or flash memory card. For more information on this, please refer to U.S. patent application Ser. Nos. 11/319,835 and 11/319,259 to Gonzalez et al., which are hereby incorporated by reference in the entirety.

### SUMMARY OF THE INVENTION

The present invention adds flexibility to a device that can automatically generate and submit passwords for a user. It allows a user to be able to generate, read, and enter a one time password in situations where he would otherwise not be able. It therefore provides maximum flexibility and allows use of a one time password in any scenario where it may be called for. In addition, in one preferred embodiment it is designed for use with a portable mass storage device such as a USB flash drive or memory card, that in addition to large file storage capability also has one time password generation and password management capability. In such a case, the reader of the present invention supplies power, and in certain embodiments, a real time clock signal to the mass storage device. Without power the mass storage device cannot function, whether for file storage purposes or password generation and management purposes. Also without a real time clock signal, time based OTP generation is not possible in such a mass storage device.

Therefore, when the reader of the present invention is connected to such a mass storage device, it enables the connected ensemble to generate and display one time passwords that can be entered manually by a user. The password generation can be triggered by the connection of the reader to the device, or can alternatively be triggered by the press of a button on the reader. The password generation can be time based or event based. When the user prefers to have the password values submitted directly, he can disconnect the reader and plug the mass storage device directly into a host.

The reader preferably has a form factor of a cover or cap for the mass storage device. For example, if the mass storage device is a USB flash drive the reader can act as a cap for the USB connector of the device. Such a cap would be a convenient and functional accessory for a USB flash drive. If the mass storage device is a memory card, the reader can act as a cover or carrying case for the memory card, which would likewise be a convenient and functional accessory for a memory card.

Such an accessory would be far more useful than, for example, smart card readers that can read (but not directly display) OTP data from a smart card, but are essentially computer peripherals that must be plugged into a computer to do so. In addition, the mass storage device and reader combination also has the advantage of being able to store and transport a user's photos, music library or other large files, which is not possible with a smart card or with prior OTP tokens.

### BRIEF DESCRIPTION OF THE FIGURES

In the following figures, the same reference numerals are used for the same or similar objects throughout the figures.

FIG. 1A is an illustration of system 100, an embodiment of the invention, including mass storage device 100A and one time password reader 100B.

FIG. 1B is an illustration of system 100 where mass storage device 100A and one time password reader 100B are coupled together with their respective connectors.

FIG. 1C is an illustration of one time password reader 200, according to another embodiment of the present invention.

FIG. 1D is an illustration of another embodiment of system 100.

FIG. 1E illustrates the embodiment of system 100 depicted in FIG. 1D where mass storage device 100A and one time password reader 100B are coupled together with their respective connectors.

FIG. 2A is a block diagram illustrating the components of mass storage device 100A and one time password reader 100B.

FIG. 2B is a block diagram illustrating the components of mass storage device 100A and one time password reader 100B that may be used for both event based and time based one time password sequences.

FIG. 2C is a block diagram illustrating the components of mass storage device 100A and one time password reader 200B.

FIG. 2D is a block diagram of the larger system 100.

FIG. 3 is a diagram illustrating the functional distribution within system 100.

### DESCRIPTION

While systems are developed that make OTP generation and submission an automated and nearly invisible process for a user, there are inevitably times when a user may need or want to read and then manually enter a one time password value. The present invention adds this flexibility to OTP generating devices that are designed to normally automatically submit OTP values directly to a host device.

One time passwords have in the past typically been generated by dedicated tokens, such as the type which may be attached to a keychain. Those tokens display a value which the user then types into a host device such as a personal computer, cellular telephone, personal digital assistant or other electronic device connected to a network such as the Internet. The host then transmits the submitted value to a verifying entity, or server on the network which then compares the submitted value to a value calculated by the verifying entity. If the values match, the user can gain access, assuming other verification criteria are met, if present.

For many reasons, usage of the one time password has not gained widespread acceptance. One reason is that the dedicated tokens are inconvenient, because they are an extra piece of hardware a user must carry around at all times in order to gain access. Therefore, to facilitate greater usage of one time password systems and increase security, one time password generation is being incorporated into a range of devices. One such device is the flash memory based portable mass storage device (“MSD”), which may be a USB flash drive, or a memory card. Because many users already have and often carry these devices around for use with digital cameras, phones, music players, general purpose computers, and the like, they are a convenient vehicle for password management, including one time password generation and two factor authentication. These devices may generate and automatically submit the one time password to the verifying entity. While this greatly simplifies the process for the user when he is in a situation where the direct submission is an option, many times it is simply not an option because the user does have access to an appropriate port to connect the device to a host system, or otherwise may not want to connect it. For more information on a MSD with one time password generation and password management, please refer to U.S. patent application Ser. Nos. 11/319,835 and 11/319,259 to Gonzalez et al., which was previously incorporated by reference in the entirety.

In contrast to a one time password token, a MSD is not self powered, and therefore must be connected to power source for all operations, including the generation of one time passwords. For example, a memory card must be inserted in a camera in order to store or view an image file, and a USB flash drive must be plugged into a USB receptacle in order to manipulate files on the drive. Otherwise while it is in your pocket it is inactive. In contrast, a dedicated OTP token has a battery to produce values at any time. In fact, some time based tokens always display the current value of the one time password. Other time based tokens display the value only upon request, and event based tokens only generate and display the value when requested or triggered.

A time based OTP generation scheme relies upon a real time clock in order to regularly increment from one seemingly random number to the next. The sequence of values is in fact very predictable, and that is how it can be compared to the sequence of values calculated by the verifying entity. With a given algorithm and seed, the series of numbers that will result is known. However, to one without knowledge of the seed and/or algorithm the numbers appear random and the process is therefore referred to as pseudo-random number generation. In contrast, as mentioned previously, an event based OTP generation scheme relies on an event to update the count within the sequence of (pseudo random) values. A challenge response based system uses some other secret or credential with an algorithm to generate the value.

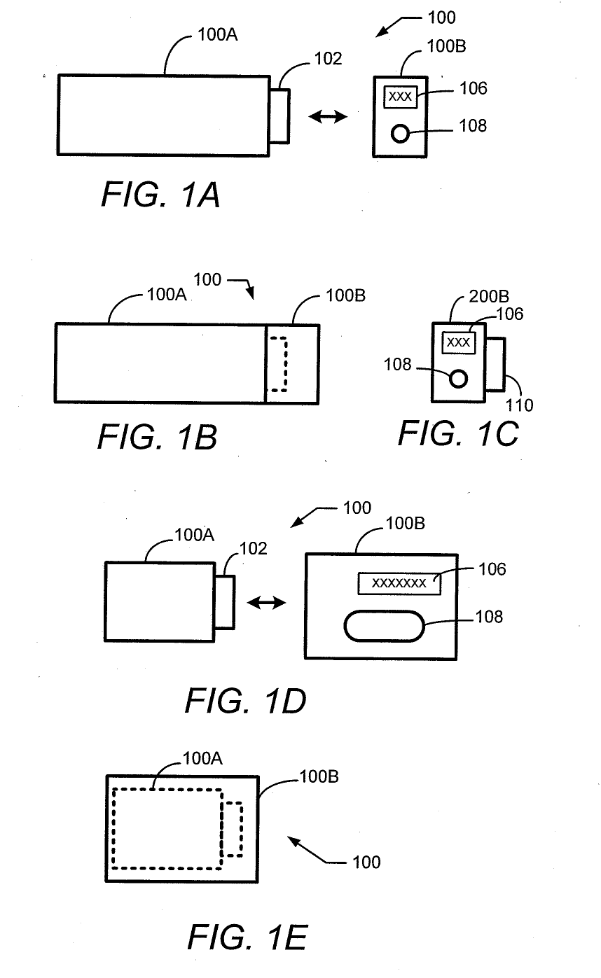

FIG. 1 illustrates system 100 which comprises MSD 100A and OTP reader 100B. MSD 100A is illustrated as a USB flash drive, although it may also be a mass storage memory card. MSD 100A comprises a connector 102, which in the case of USB flash drive comprises a USB connector, whereas in the case of a memory card connector 102 comprises the contacts of the card. OTP reader 100B is preferably in the form of a cap or cover for MSD 100A. In this way, as an accessory for the MSD, when coupled to the MSD it can display the one time password to the user. The user need simply put the cap on the device to read the value. The body of the cap or cover can cover all, substantially all, or only a portion of MSD 100A. As seen in FIG. 1A, OTP reader 100B covers the USB connector 102 of MSD 100A. Providing the reader with the form factor of a removable cap/cover makes it convenient for the user to couple it to the MSD and also to transport it when not in use. In some embodiments the cap may be tethered or otherwise connected to the MSD while it is not directly on the connector. For example, all or a portion of the cap may be tethered to the MSD 100A. This can be accomplished in any number of ways, including a flexible member, hinge, or sliding mechanism among others. Although it is preferred that the reader have the form factor of a cap or cover, the reader may have any easily transportable or, generally speaking, pocket-sized form factor. While the OTP reader 100B may be referred to hereafter as the preferred form factor of a cap or cover, it should be understood that it is not limited to such a form factor.

In certain embodiments, the placement of the cap on the MSD will automatically trigger the device to display the value on display 106. In other embodiments, a button 108 is provided, and the user must first depress the button before the value will be displayed. FIG. 1B shows the MSD 100A coupled to OTP reader 100B. The OTP reader comprises an electronic connector or receptacle 124, not shown, for making connection to connector 102 of MSD 100A, as will be illustrated and described later. As seen in FIG. 1C, the cap may also have a second connector 110. This connector is for making connection to a host device, although either connector 102 or 110 may be coupled to any sort of electronic device. In the embodiment where MSD 100A is a USB flash drive, connector 102 would preferably be a male USB connector, and connector 124 would preferably be female. Connector 100 would therefore preferably be male in such an embodiment. In such a case, the reader 100B can be coupled to both MSD 100A and a host or other electronic device simultaneously.

FIGS. 1D and 1E illustrate an embodiment of MSD 100A where the reader 100B is larger in one or more dimensions than MSD 100A and covers all or almost all of MSD 100A. Note that one or more faces or sides of MSD 100A may be exposed. Such a form factor of reader 100A would be preferable when MSD 100A is relatively small, for instance if it is a relatively small USB drive or memory card. If the mass storage device is a memory card, the reader can act as a cover or carrying case for the memory card, which would likewise be a convenient and functional accessory for a memory card. Although any mass storage memory card with OTP fuctionality can be used with the present invention, use with the SD card, mini-SD card, or micro-SD card, also known as the TransFlash™ card, yields a particularly portable and desirable system 100.

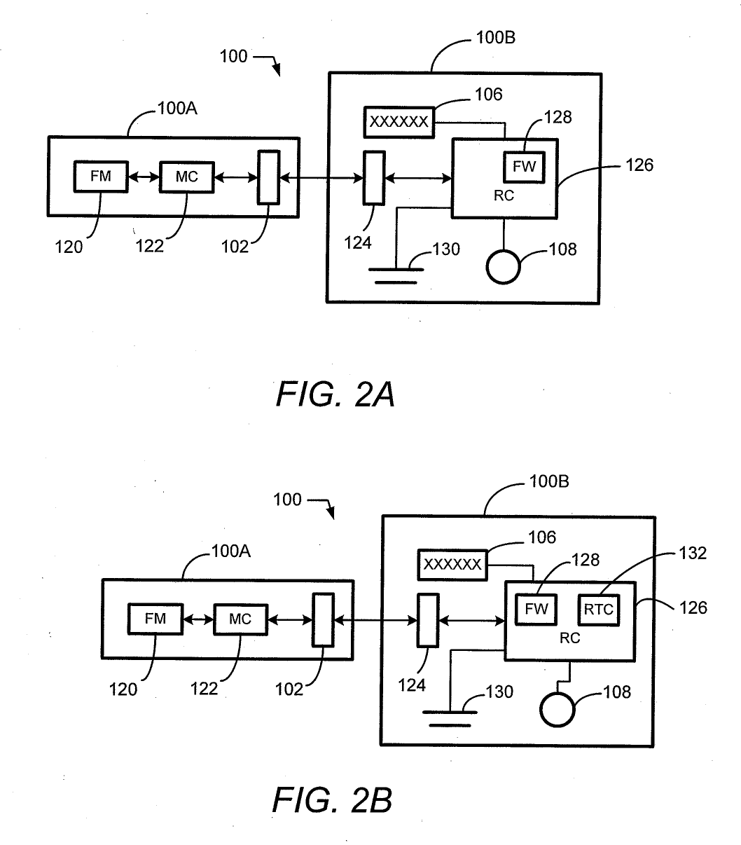

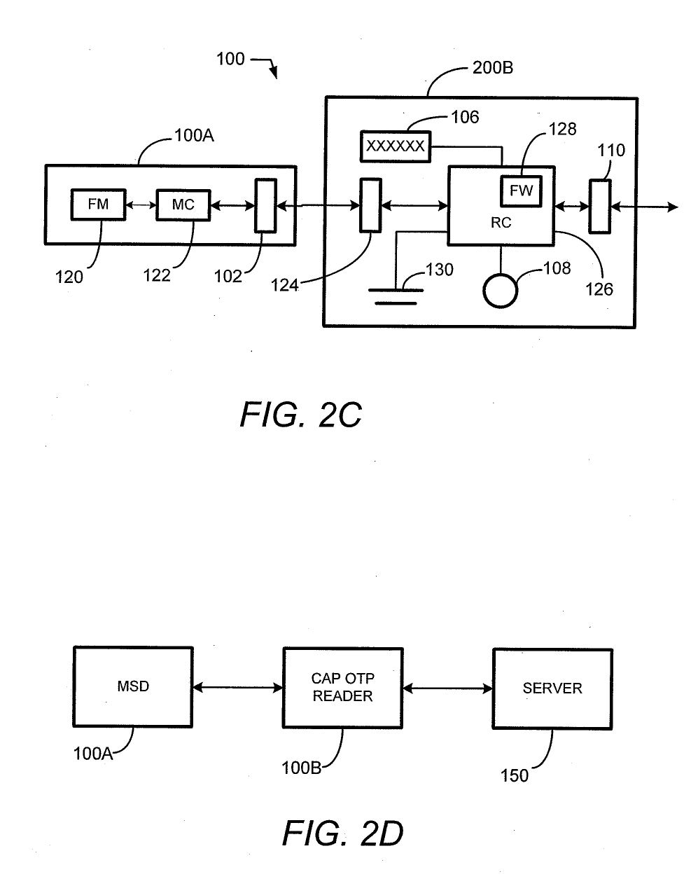

FIG. 2A is a schematic diagram illustrating the main components and connection of MSD 100A and reader 100B. MSD 100A comprises connector 102, memory controller 122 and mass storage flash memory 120. Memory controller 102 controls the read/write operations of mass storage flash memory 120, and the overall operations of MSD 100A, including transfer of data to and from MSD 100A via connector 102. As mentioned previously, MSD 100A does not typically have a power source because, as it is primarily a data storage device for a host, it typically receives power from the host. Likewise, mass storage drives may also rely on a clock signal from the host.

Reader 100B comprises a connector 124, display 106, reader controller circuitry 128, including firmware 128, battery 130, and button 108. Reader controller (“RC”) or controller circuitry is preferably an application specific integrated circuit or “ASIC.” Logic within the OTP controller, e.g. firmware 128, is designed to control the reader, and the various interactions it may have with other devices. Connector 124 is preferably a female USB connector in the case of a USB flash drive embodiment of MSD 100A or a card socket if MSD 100A is a mass storage memory card. Battery 130 supplies power to both reader 100B and MSD 100A. The battery can be rechargeable, replaceable, or alternatively the reader may be disposed of when battery 130 can no longer hold a charge. It is preferable that the battery can be recharged or replaced unlike many OTP tokens that must be disposed of when the battery dies.

Button 108 may serve to trigger the generation and display of an OTP value on screen 106. Alternatively, the connection of MSD 100A and reader 100B may trigger the generation and/or display of the OTP value. While the presence of button 108 is preferable, certain embodiments may omit the button altogether, and simply rely on the interconnection of the devices as a trigger.

FIG. 2B is the same in most respects to FIG. 2A but RC 126 in FIG. 2B also comprises a real time clock 132. This embodiment is designed to work with embodiments of system 100 and MSD 100A that are capable of time based OTP generation and authentication. When reader 100B is coupled to MSD 100A it supplies the real time clock signal to the memory controller 122. This signal is then used to create the time based one time passwords within MSD 100A. In embodiments of MSD 100A that do not have a real time clock, the signal would otherwise come from the host device in order to generate time based passwords. RC 126 and reader 100B may also supply any other credential to MSD 100 for use in more general challenge-response type OTP generation.

FIG. 2C is also similar in most respects to FIG. 2A, but also comprises connector 110. This second connector can be used to connect to another device at the same time that reader 100B is connected with MSD 100A. It can be a standardized or proprietary connector. As mentioned previously, either connector 124 or 110 can be used to recharge battery 130. In the case where connector 124 is a female USB connector, it is preferable that connector 110 be a male USB connector because it can readily be plugged into a female USB receptacle on a computer to receive power for charging or other operations. Such a second connector can be implemented in any embodiment including those that have a real time clock.

FIG. 2D illustrates system 100 again, in a larger context. One time passwords are used in authentication systems. System 100 may therefore also comprise one or more remote servers 150. The password generated in such a system, as mentioned previously, is compared against that generated by a remote server 150 accessed over a network. Another remote server 150 may optionally serve to keep track of the count of MSD100A for event based OTP generation and may provision and store information needed for OTP generation. Access to any remote severs is preferably carried out over a secure connection with a secure session established between entities.

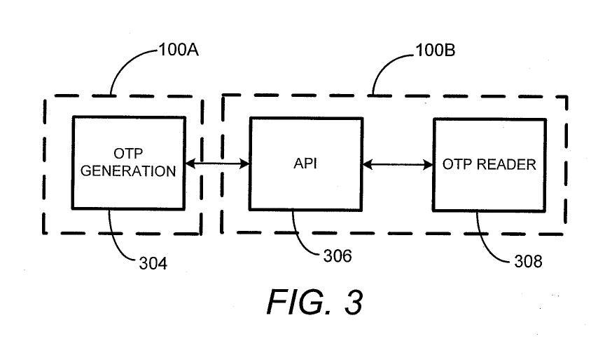

FIG. 3 is a schematic illustration of the functionality of the system. OTP generation 304 takes place in MSD 100A. The generated OTP value is transmitted to reader 100B and may be temporarily stored in a memory of MSD 100. If the value is stored, it may be stored in a secure area or an openly accessed area, and the reader can access the value by reading a location of the memory where the value is expected. The display functionality of the value generated by MSD 100A takes place within reader 100B. MSD 100 is capable of using a range of different algorithms and processes for generating values for use as one time passwords. Reader 100B can function with these different algorithms and processes by utilizing application programming interfaces (“APIs”) coordinated with and tailored to them. These APIs 306 would be implemented within RC 126 of reader 100B.

Prior OTP tokens incorporated both the display and the generation mechanism, and thus it was not necessary to incorporate an API within the tokens. This is because the reader was only meant to function with one specific OTP generating sequence/algorithm, that of the token it was integrated into. The system of the present invention is flexible and provides for a reader that can coordinate OTP generation with OTP generating devices utilizing a wide array of time based, event based, and challenge-response schemes, and a wide array of different algorithms.

The ability to view and manually enter OTP values from devices otherwise designed to automatically submit the values adds another dimension of flexibility to security systems, and should not only make usage easier for the user, but should also increase penetration and acceptance of OTP based systems.

While embodiments of the invention have been described, it should be understood that the present invention is not limited to these illustrative embodiments but is defined by the appended claims.

It is claimed:

1. An accessory for a one time password generating device not having a display, the accessory comprising:
a display that displays values generated by the one time password generating device;
a first connector, the first connector operable to be connected to the one time password generator; and
controller circuitry that controls operations of the accessory, including displaying a one time password value generated by the one time password generating device.

2. The accessory of claim 1 wherein the accessory has the form factor of a cover of at least a portion of the one time password generating device.

3. The accessory of claim 1, wherein the one time password generating device has a USB connector and the accessory has the form factor of a cover for the USB connector of the device.

4. The accessory of claim 1 further comprising one or more interfaces, each interface operable to function with a different one time password generation method of one or more one time password generating devices.

5. The accessory of claim 1 further comprising a button for triggering the controller circuitry and the display.

6. The accessory of claim 1 further comprising a second connector, the second connector operable to be connected to a host device.

7. The accessory of claim 6, wherein the first connector is female and the second connector is male.

8. The accessory of claim 6, wherein the host device provides power to the accessory when it is coupled to the host device via the second connector.

9. The accessory of claim 8, wherein the power provided recharges a battery within the accessory.

10. The accessory of claim 1 further comprising a real time clock, the accessory operable to provide a signal from the real time clock to the one time password generating device.

11. A system for authenticating a user;
a mass storage device comprising a memory controller that controls reading and writing of data to and from a mass storage memory of the device and that also generates a pseudo random number; and
a reader that can be physically coupled to and uncoupled from the mass storage device,
wherein the reader triggers the controller to generate the pseudo random number,
and wherein the reader displays the pseudo random number generated by the mass storage device.

12. The system of claim 11 further comprising a host that accepts the manual input of the pseudo random number displayed by the reader.

13. The system of claim 11 further comprising an entity that verifies that the pseudo random number generated by the mass storage device is the same as a pseudo random number generated by the entity.

14. An authentication system comprising:
a device operable to generate but not to display one time passwords, the mass storage device comprising a host connector;
a reader operable to display but not generate one time password values when connected to the host connector of the device.

15. The system of claim 14 wherein the mass storage devices generates time based one time passwords, and the reader supplies a clock signal used by the mass storage device.

16. The system of claim 14 wherein the reader comprises a connector, the reader operable to recharge itself through the connector.

17. A removable cover for a one time password generating device not having a display, the cover comprising:
means for causing the one time password generating device to generate a one time password; and
a display for conveying the one time password generated.

18. A removable cover for a one time password generating device not having a display, the cover comprising:
an integrated controller circuit;
a user input coupled to the integrated controller circuit,
the integrated controller circuit operable to cause the one time password generating device to generate a one time password; and
a display that displays the generated one time password to the user.
